(19) United States
(12) Patent Application Publication
(10) Pub. No.: US 2005/0016269 A1
(43) Pub. Date: Jan. 27, 2005

(54) Structural Integrity Monitor

(76) Inventor: Igor Touzov, Cary, NC (US)

Correspondence Address: IGOR V TOUZOV, 311 CASTLE HAYNE DRIVE, CARY, NC, 27519, US

(21) Appl. No.: 10/710,574

(22) Filed: Jul. 21, 2004

Related U.S. Application Data
(60) Provisional application No. 60/481,123, filed on Jul. 22, 2003.

(51) Int. Cl. G01N 7/00

(52) U.S. Cl. 73/432.1

(57) ABSTRACT

Method and apparatus of completely passive and nondestructive monitoring of structural integrity of simple and complex objects. Apparatus is extremely compact, lightweight, inexpensive, and statistically precise and reliable.

### CROSS REFERENCE TO RELATED APPLICATIONS

This application claims the benefit of U.S. Provisional Application Ser. No. 60/481,123 filed July 22, 2003.

### BACKGROUND OF INVENTION

The method of the present invention belongs to area of nondestructive testing (NDT). Contrary to common practice this method implies completely passive monitoring technique. Mostly modern NDT technologies employ active methods of interaction with the test subject that employ external sources of test substances or other distortions. The most common of them are: Visual inspection; Liquid penetrant; Acoustic emission; Eddy current; Ultrasonics; Radiography; Magnetic particles; Acousto-photonic.

Out of these technologies Visual inspection and Liquid penetrant are the most difficult ones, which require significant manual labor.

Acoustic emission (AE) is the most popular technology on today's market. It allows efficient automation of testing and centralized access to information. The core phenomenon for this technique is emission of ultrasonic wideband sound at moments of defects formations. Successful acquisition of these sounds and following sophisticated analysis allows pinpoint accuracy in defect detection. Main and fundamental disadvantage of AE is inability to identify defect that already occurred. This imposes requirements of continuous and uninterruptible monitoring, which makes AE less robust and more vulnerable due to excessive weight and power losses. In addition fracture analysis is only as good as analytical software that is used, and may cause insignificant defects to trigger alarm of structural integrity breach.

Eddy current technology is limited to conductive materials. Originally it was used as test and not monitoring technique due to physical requirements of the sensors. Recently, advances in this technology extend it to methods of remote monitoring.

Ultrasonics is based on active scan of a system using source of ultrasound waves. This technology has been mostly replaced by AE. One of the reason for drop in its popularity is complexity of this technique that required considerable technical training and skills.

Radiography uses penetrating radiation to examine structure of a system. Method is very similar to visual inspection and also imposes limitations on set of equipment that can withstand the radiation. This technique is time consuming and can only be used for testing.

Magnetic particles inspection technology allows finding flaws on and near surface in ferromagnetic materials such as steel and iron. It is very sensitive to surface irregularities and scratches and requires careful surface preparation. This limitation makes this technique applicable to very narrow set of tasks.

Acousto-photonic technology is recently emerged. It combines ultrasonic inspection technology with advances of scanning laser vibrometry and computer analysis. This technology has highest price tag on the market and offered by Honeywell Corporation. Due to its price and complexity it is affordable to very small group of customers.

The method of the present invention uses sophisticated automated analysis of data from passive sensors that gives the method significant advantages over other passive techniques that rely on manual work. The absence of energy emitting components in implementations of the method allows significant increase in its reliability and lowers power utilization. That makes its implementations more competitive in size and weight as well.

The method of the invention provides continuous monitoring similar to AE., but effect of power failure or even complete disconnect does not invalidate structural integrity status, which makes the method of the invention more robust.

### SUMMARY OF INVENTION

This invention discloses novel method and apparatus that allow continuous monitoring of structural integrity of components and assemblies at relatively low cost. The apparatus is highly autonomic and low weight that permits its use on variety of systems and components.

The method of the invention belongs to NDT techniques. It uses single or plurality of passive sensors at least some of which are capable of providing time variable response. The primary idea of the method is the use of variable plurality of unknown external and/or internal distortions applied to the subject of monitoring. These distortions act as a source of test signals that are registered by attached sensors. All known NDT approaches rely on know sources of test signals or monitor just particular critical events as in case of AE testing.

The method disclosed in the present invention does not rely on such events but instead determines structural integrity of the subject by testing its integral pattern of sensor's signals on compliance with a priory found pattern characteristics. The set of such characteristics can be established once or can be dynamically build and/or adjusted continuously or periodically.

Another benefit of the method is its ability to use low cost sensors, it can be sorely based on the use of slow response low bandwidth acoustical, thermal, pressure, etc sensors.

### BRIEF DESCRIPTION OF DRAWINGS

FIG. 1 shows example of activity model associated with the method of the invention.

FIG. 2 shows example of isolated node linked to multiple passive sensors.

FIG. 3 shows a version of block diagram for profiling of the system using simple autocorrelation filter.

FIG. 4 shows two examples of implementation algorithms for the network of monitoring nodes.

### DETAILED DESCRIPTION

Method

The method of the invention uses concept of LTI (linear time invariant) system with steady states. Structural integrity of such systems is one of possible applications of the method. The method is based on use of only passive detection techniques and it collects data from single or multiple passive sensors that report momentary values of distortions propagating through the system. The sources of these distortions are events external to the subject of the invention and the use of the present invention is not bound to them. Examples of the sensors are temperature, acoustic, voltage, current, resistance, deformation, pressure, photo, flow rate etc. The sensors can be homogeneous and measure only single type of distortions, or heterogeneous and measure some combination of different distortion types.

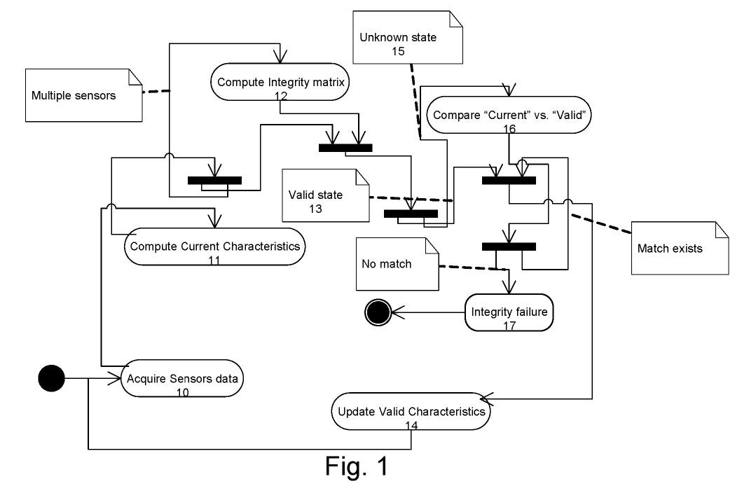

FIG. 1 shows one of possible implementations of activity model associated with this method. The method uses matrix of time series in frequency domain as a representation of current status of monitoring system. Gradual evolution of coefficients of this matrix corresponds to aging process of the system and abrupt changes correspond to events of structural changes. While normal structural changes are considered recurrent events of nominal operation of the system their projection on said matrix exists in two forms. Stateful changes create additional partitions or instances of said matrix, while small, fast or stateless changes affect characteristics of its coefficients by increasing their variance.

The values of acceptable coefficients are limited by preset collection of constraints. Runtime version of this matrix(s) has value different from one previously evaluated. The changes within the constrained region of functional space are considered acceptable, while the rest of the changes indicate abnormal change of structural integrity of the system.

FIG. 1 diagram shows time series of sensor data that acquired (10) and a set of proposed characteristics (11) computed for them. In case of multiple time series these characteristics form proposed Integrity matrix (12). The subject of the test/monitoring at some moment has to be present at a state of known integrity (13). Example of such state is “normal operational” when it is known that the subject remains in desirable conditions. This state is called Valid state (13). In valid state the set of proposed characteristics and or proposed Integrity matrix are used to update Valid Characteristics (14) of the subject. When the state of the subject needs to be determined the subject is present in Unknown state (15). The state validation occurs by comparison (16) of the proposed characteristics and or Integrity matrix versus Valid characteristics. When these two sets does not match within imposed constraints, the Unknown state is treated as invalid and Integrity failure (17) processing begins.

Following mathematical worksheet illustrates mathematical approach for described method that can be employed to compute Integrity matrix in designs that employ multiple sources of sensors signal. To simplify its understanding some details are skipped. Steady state scenario uses the same approach that results in partitioned matrix or a collection of matrixes where each matrix is linked to individual state. It is assumed that current state of the subject is Valid. This assumption is tested if previously known valid state exists, or is taken by default if no prior data exists. It is also assumed that the length of time series that represent sensors signals is sufficient to average stochastic components in those signals. LTI system defined by infinetely dimensional space G of matrixes gᵢ,
\vec{s}(t)=gᵢ\vec{f}ᵢ(t) (100)
where
\vec{s}(t) is vector of sensor readings,
\vec{f}(t) is vector of unknown stimuluses, and
iε[0,∞) for complete functional space P of stimuluses.
Space P is defined through complete set of locations and types of external and internal distorsions appliable to the system. Functional space K superseeds P by addition of functional space of sensor readings:
   K=P∪S

Functional vectors in space K constructed as

$${k}^{->} = \vert \begin{matrix}{s}_{0} \\ ⋮ \\ {s}_{n} \\ {f}_{0} \\ ⋮\end{matrix} \vert ,$$

where n is number of sensors attached to the system.

The same system will remain LTI when considered in space Q of matrixes qⱼ
\vec{s}(t)=qⱼ\vec{k}ᵢ(t) (200)

Space of rectangular matrixes qⱼ has invariant square minor of rank n
qⱼ=|Mₙ . . . |

It can be found from equation 200 as
\vec{s}(t)=M\vec{s}ᵢ(t)+hᵢ\vec{f}ᵢ(t) [symbol] hᵢ\vec{f}(t)=\vec{0}, and

$$M = \vert \begin{matrix}0 & {m}_{1}^{0} & ⋯ & {m}_{n}^{0} \\ {m}_{0}^{1} & 0 & & ⋮ \\ ⋮ & & ⋰ & {m}_{n}^{n - 1} \\ {m}_{0}^{n} & ⋯ & {m}_{n - 1}^{n} & 0\end{matrix} \vert$$

Matrix M remains constant within preset constraints while structure of the system remains unaltered. Coefficients of the matrix can be found from equation shown on next mathematical worksheet:
\vec{s}(t)=m\vec{s}(t) [symbol] F(\vec{s}(t))=F(m)F(\vec{s}(t)) [symbol] \vec{S}=M\vec{S} (300)
where F is Fourier transform

Each row of the matrix M contains n-1 unknown complex functions. In order to find all n²-n unknown coefficients of the matrix at least n-1 distinct distortions have to be registered by the sensors. The time span of the registration defines spectral range of the matrix M and repetitive distortions increase precision of the matrix coefficients. Each coefficient in the matrix M is obtained as an average across all solutions of equation (300) found over specific period of time. Each of the coefficients can be stored as a combination of vectors of its average and variance.

Stateful transitions of the system results in statistically significant clustering of coefficients of the matrix. This clustering is used to create separate partition in the matrix or in some cases separate version of said matrix associated with particular steady state.

Matrix Mallows efficient solution in cases of multiple sensors. In case of single channel designs the convolution operator has limited use. More efficient approach for this case is a use of preset filters. Autocorrelation, self convolution in Fourier space, match-filtering are just some examples of such filters. The role of the filter is to discover nonrandom characteristics in plurality of sensor data sets. For one experienced in art of digital filters and signal processing it is obvious that plurality of standard algorithms can be used in this method, as well as custom filters can be constructed to suite special design tasks.

Results of these filters across plurality of valid datasets are analyzed on presence of clusters and each cluster creates separate partition in space of detected Characteristics. Each partition contains a set of Characteristics associated with specific cluster. In consideration of steady-state model each cluster may represent separate state.

In order to validate current integrity state of the subject its sensors needs to be pooled and a new set of characteristics and or matrix to be computed. Their values are compared versus all partitions of the characteristics sets and or the matrixes. If matching partition exists the current integrity state of the subject is valid, and newly polled datasets can be merged with matching partition.

For one experience in the art of software development and signal processing it is obvious that variety of alternative algorithms can be chosen to implement disclosed idea. The method disclosed in this invention does not intend to limit this idea to one example implementation and only serves as an example to illustrate the primary subject of the invention. It is also obvious that method can be optimized for various hardware implementations and can use sequential, parallel, incremental, recursive and plurality of other alternatives.

Algorithm

Algorithm that illustrates the method of this invention operates in one of the following modes:

Perform initial profiling of the system that involves: 1) periodic or non-periodic acquisition of all sensor channels over some time period; 2) computation of structural Integrity matrix M and/or persistent Characteristics, standard sensor noise level and achievable detection speed. Detection speed or timing depends on multiple factors such as reliability and quality of sensors, average level of standard distortions and their types, physical properties of the system. Long timing indicates that structural integrity alert signal will be raised with significant delay after structural integrity of the system being affected. The term initial only indicates that the subject system is considered to be in Valid state. The profiling can be performed at any time the state of the system is Valid.

Validate integrity acceptance constrains, which may include constraints for slow age related structural degradation, maximum and minimum magnitudes of distortions, acceptable level of abrupt change of structural matrix, minimum allowable number of functional sensor channels, etc. It is possible to consider scenario when some of the sensors fail and reduced subset of Characteristics is used to continue monitoring of the system.

Perform continuous profiling of the system by refining structural integrity matrix. This continuous refinement causes elements of the matrix converge to the mean values and standard deviations to their minimum. Statistically significant change in the sensor data (e.g. computed as T-test) is analyzed vs. established constraints. This mode of operation also may include status reporting or update which consists of active communication between the monitoring system and other functional elements, and may rise preliminary warnings and alerts indicating significant structural changes in the system that are still within allowable range.

Switch to standby or hibernation mode that allow system to remain inactive and reduce or eliminate power consumption while integrity monitoring is not required. This mode can be actively used by the system when level of receivable distortions falls below established detection threshold.

Switch to monitoring mode and perform comparison of current structural Integrity matrix and or persistent Characteristics versus Valid Characteristics and accepted change trends. This mode of operation also may include status reporting or update which consists of active communication between the monitoring system and other functional elements, and may rise preliminary warnings and alerts indicating significant structural changes in the system that are still within allowable range.

Switch to alert mode and rise integrity degradation signal when current Characteristics does not fit into allowable constrained functional space or any other constrains are violated. This mode can be reset manually or automatically and initial profiling of the system executed.

Apparatus

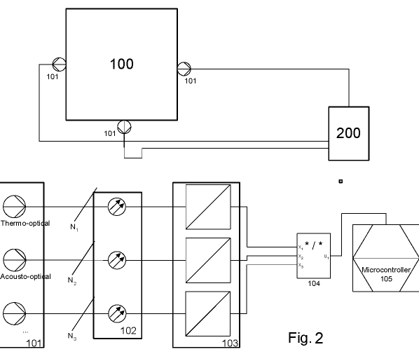

FIG. 2 shows schematic of basic node of the invented apparatus. A network of the nodes can form very sophisticated structural integrity monitoring systems. Component or system 100 that needs to be monitored equipped with plurality of sensors 101 that linked with the apparatus 200 that formed by plurality of nodes. As an example thermal and acoustical sensors with optical transducers are shown. It was previously described, the types of sensors may vary as well as any number of redundant sensors can be used. Lower part of the picture shows these sensors connected through optical or electrical busses 102 to signal converter/amplifier 103 which transforms all sensor outputs to the same form. These signals are further converted into digital form by converted 104, which may be integrated into processing module 105. Processing module 105 executes all methods and algorithms described in the previous sections and can be implemented as a digital microcontroller, DSP, generic processor, computer, optical computer or any other means capable of performing the method of the invention.

It is obvious that with current level of development of integral electronic/optical components the unit 102/200 can satisfy any interface requirements necessary for communications with various types of external digital and analog equipment.

### EXAMPLE 1

Simplest implementation of described apparatus can be illustrated on example of single sensor channel attached to complex body, the structural integrity of which needs to be monitored. Examples of such body are: passive structure like building, combustion engine, rail beam, etc. Where in said sensor may acquire acoustic vibrations, or thermal variations, or other distortions. Acquired signal from the sensor has limited bandwidth with fixed low and upper cut-off frequencies. The sensor is attached through ADC converter to notebook computer that performs functions of controller by executing user-level code.

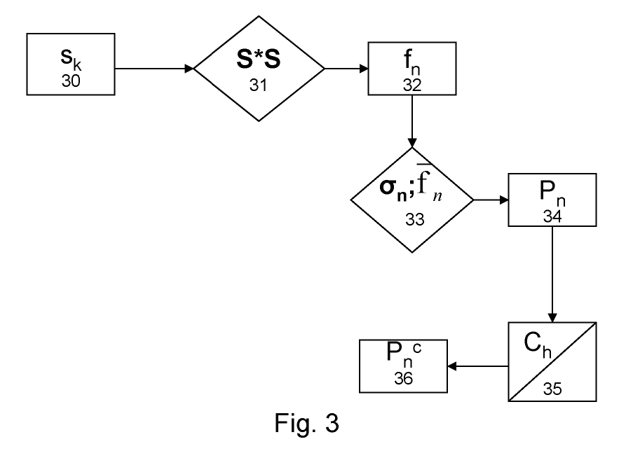

Initial profiling of the system illustrated on FIG. 3. It uses normal set of disturbances (30) the body is subject to during normal use. Data series sₖ from sensor processed using predefined set of custom filter functions. As a trivial example consider scenario that uses single circular autocorrelation filter (31) applied to the phase of FFT transform of each captured dataset. Output from the filter contains lag series f (32). It is assumed also that during initial profiling integrity of the body does not deteriorate. The lag series merge into family (34) of populations Pₙ, where n- represents the lag value. Each population (33) represented as average and variance of filter output for specific lag.

Profiling process is always treated as static stochastic process regardless of type of disturbances. This assumption is true even in the case when the process have multiple states. Each population Pₙ checked on presence of significantly separated clusters (35) using one of standard statistical approaches. In this example paired student T-test is employed to find the clusters. This process results in collection of Pₙ^{c} populations (36), where c- is identifier for specific state/cluster.

Predefined acceptance constraints then applied on these populations to filter out all collections that do not satisfy the constraints. In this example trivial constraint C ₀ is used that places a limit on maximal relative standard deviation. In generic case such constraint should be used in combination with other constraints. Herein to simplify the example this constraint is set along that results in final set F of populations Pₙ^{c}.

The trivial case of implementation does not allow incremental or continuously adjustable profiling, so when initial profiling process completes, the process of strict monitoring starts. Sensor continues to produce data series that processed by the same filter function. Results of the filter checked against static set F and confidence intervals are computed to validate match of the results to each Pₙ^{c}.

Aging of the body or its direct damage causes failure of specified test which results in positive integrity failure signal.

### EXAMPLE 2

Following are examples of standard filters used in conversion of single sensor signal: autocorrelation of signal, autocorrelation of power spectrum of the signal, cross-correlation of sequential signal datasets, cross-correlation of rows in accumulated table of datasets, custom match-filtering, etc. Requirements and resources for each type of filter vary that allows in each particular implementation use only small number of most suitable filters.

### EXAMPLE 3

In example 1 the method implementation was restricted to case of negative identification, that means only missed characteristic were used to trigger an alarm. In broader case the method implies dynamic profiling of the body. As a result of such profiling new characteristics can be added to system identification set in a way that prior characteristics do not change.

This type of positive identification in many practical cases can be treated as a potential safety warning. Example of such scenario is unexpected consistent water leak. While no direct structural degradation occurred, the leak creates new consistent nonrandom signal pattern, which creates new characteristics for the system in dynamic profiling of the body. It is useful to allow the method to report such change as a warning.

Another example of positive identification is appearance of new low variance Characteristics. Such example comprises a case of spinning fan that suddenly stops. Noise from the fan prevented some Characteristics of the system to be accepted due to constraint C₀. Reduction of disturbances caused by stalled fan allows those characteristics to be included, and indicate potential Integrity degradation of the system.

Structural Integrity Network

The invention discloses method and apparatus of building complex systems containing multiple components and or subsystems equipped with structural integrity apparatuses and or networks described in this invention. Each component or subsystems equipped with structural integrity apparatus or structural integrity network is defined as a node. Nodes are connected through parallel or serial communication channels, wherein the channel may be established statically or dynamically and be implemented as wireless or physical connection. Each node is capable of sharing sensors readings in raw or processed form as well as elements of the structural Integrity matrix M and/or persistent Characteristics.

Structural matrix of a system containing multiple nodes is shown on mathematical workout sheet:

$${M}_{system} = \vert \begin{matrix}{M}_{11} & {M}_{12} & ⋯ & {M}_{1 n} \\ {M}_{21} & {M}_{22} & {M}_{ij} & \\ ⋮ & & ⋰ & \\ {M}_{n1} & & & {M}_{nn}\end{matrix} \vert$$

when i=j the minor Mᵢⱼ is structural matrix of an individual node, for i≠j a new minor Mᵢⱼ is computed using sensors readings of both node i and node j.

Structural matrix of the system or the network has rank not exceeding sum of ranks of all nodes which it composed of. In practical applications structural matrix of the network can be selected to have smaller rank by exclusion rows and columns with high variance or narrow frequency spectrum.

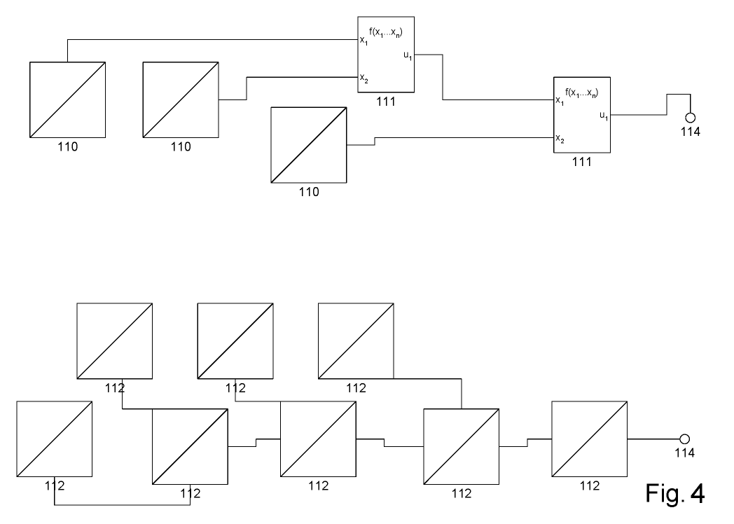

Such selection can also be dictated by type of the nodes. FIG. 4 shows two examples of implementation algorithms for the network.

Nodes of type 110 does not have capabilities to receive external sensor data due to limitation of their processor resources, they form tree-like network by means of hubs 111 that receive sensor data from several nodes and perform computation of sub-system structural matrixes using the method of the invention, and monitor integrity of the system part that associated with linked nodes.

In some implementations nodes of type 110 does not have processing capabilities and only capable of initial conditioning of the signals and transmitting their data to other node types.

Nodes of type 112 have enhanced processing capabilities and are capable of processing data from sensors of own node as well as compute sub-system structural matrixes using data from other nodes.

Topology of these networks allows incremental addition of components to the system. A resulting system has built-in expandable and scalable structural integrity monitoring capabilities.

These networks can be connected to other types of information networks and or communication means. Some example of those are Internet, Telephone, Cellular, wireless networks. Due to low bandwidth nature of the signals from the sensors, analysis and processing of the data can be hosted in remote processing nodes. This way complexity and cost of implementation of the method can be reduced even more.

Complex subjects or subjects with large geometrical/geographical dimensions may implement the method by means of communication through public or private information network. Processing nodes of type 111 or 112 may be employed to discover persistent signal Characteristics that associated with remotely located nodes. Examples of such implementations: bridges, stationary platforms, land masses. In case of land masses the some apparatuses of the invention my be placed on mountain ridge while others buried near a shore line. Nodes in mountain locations can be linked to public telephone network through cellular connections to nearest tower, while nodes on shore line can be directly connected to telephone lines. This way processing nodes can located anywhere on earth. Violation of the persistent Characteristics in the pattern of the signals and invalidation of structural integrity in such system my be an indication of approaching landslide, earthquake, or some other major events.

Due to high energy efficiency the nodes of type 110 can utilize renewable power sources or even accumulate energy form connected signal networks.

Applications

The method and its implementations disclosed in this document in addition to NDT allows to extend it applications to areas outside of NDT domain. In previous sections of this invention it was shown that the method can be used to monitor normal operations of complex systems and report their partial/complete malfunctions, that are not caused by structural degradation.

The method allows extension of its analysis to powerful and or external processing nodes that are capable of performing forecasting structural failures and or malfunctions.

It is obvious to one experience in the art that the method and apparatuses of the invention can be implemented to provide NDT and malfunction monitoring for static structures, vehicles, marine structures and marine vehicles, aircrafts, spacecrafts and space based structures, geological structures such as mines, gas deposits, oil deposits, large land masses, etc.

In some implementations the method can be used to report not only failure or degradation of structural and functional characteristics but also unusual usage events and or patterns, that in some cases can also be used for security purposes. Example of such implementation can be acoustic sensor located inside the building that detects alteration in acoustic reverb of the room caused by open door at unusual daytime.

1. A method of nondestructive structural and functional integrity monitoring of a subject that do apply any type of energy to the said subject or an aggregate said body is a part of, where in examples of such energy are electromagnetic waves, voltages, currents, deformations, acoustic waves, temperature, thermal waves. The method only uses information obtained through a set of mounted sensor(s) that measure physical properties of said subject, wherein information from sensor(s) is analyzed by automatic means to determine presence of automatically defined characteristics specific to the subject. Wherein term functional integrity monitoring also stands for malfunction detection and prediction.

2. An apparatus comprising digital processing component capable of implementing method of claim 1 and plurality of sensors providing measurements to said processor. Wherein said plurality may be formed by just one sensor.

3. A component or an assembly that has apparatus of claim 2 built-in.

4. An assembly containing more than one object of claim 3, where in the apparatuses of these objects are linked to form a single network or multiple networks.

5. A method of claim 1 that provides data that employed to report unusual usage events or usage patterns.

6. An implementation of the method of claim 1 that utilizes public informational and or signal networks to transmit and or receive information to/from remote location.

7. An object that utilizes method of claim 1 to forecast recommended time of own replacement.

8. An implementation of claim 6 wherein said remote location is in direct proximity of the subject.

9. An implementation of the method of claim 1 where in single physical node is used to process data from multiple independent subjects.

10. An apparatus of claim 2 that uses autonomous energy source.

11. An apparatus of claim 4 that uses network as an energy source.
